(19) United States
(12) Patent Application Publication
(10) Pub. No.: US 2016/0340157 A1
(43) Pub. Date: Nov. 24, 2016

(54) TRAILER HITCH MOUNT FOR PORTABLE WINCH

(71) Applicant: Jason B. Biedrzycki, Spring Hill, FL (US)

(72) Inventor: Jason B. Biedrzycki, Spring Hill, FL (US)

(21) Appl. No.: 14/715,707

(22) Filed: May 19, 2015

(51) Int. Cl. B66D 1/00; B60R 11/00

(52) U.S. Cl. CPC B66D 1/00; B60R 11/00; B60R 2011/005

(57) ABSTRACT

A trailer mount for portable winch for use with an attached conventional winching device that is attached to a conventional vehicle hitch mount behind a vehicle and allows the conventional winching to operate from an elevated position in the rear of the vehicle. The trailer mount for portable winch comprises receiver hitch extension, mounting pedestal, and mounting plate. The receiver hitch extension includes an attachment end for attaching to a conventional hitch of a vehicle as well as a receiving end on one plane, and a mounting end that extends up therefrom at a 67.5 degree angle. The mounting pedestal is adapted to be slidably positioned in the mounting end and includes a plate surface. The mounting plate is rotatably secured to the plate surface and is adapted to attach a conventional winching device to the trailer mount assembly.

### BACKGROUND OF THE INVENTION

1. Field of the Invention

This invention relates generally to force application devices and, more particularly, to an adjustable mount for a portable, vehicle deployed winching system.

2. Description of the Prior Art

The use of portable winching devices for mounting to and use from a vehicle is well known. Front mounted winching devices are commonly found integral with the front of many utility trucks and SUVs. Rear mounted winching devices are also known, but are often rendered impractical because the standard designs are prone to breaking and snapping because they cannot take routine twists and turns to which they are often subjected.

Therefore, a problem which still exists is that conventional rear mounted winching devices lack the positioning and stability to effectively operate for the typical winching operations for which they are generally required. Thus, there remains a need for a trailer mount for portable winch which would provide an elevated surface from which an attachable conventional pulley style winching device can be mounted and operated. It would be helpful if such a trailer mount for portable winch was deployed through a hitch extension so as to still allow structures to be hitched through the vehicle's hitch assembly. It would be additionally desirable for such a trailer mount for portable winch to have a winching device rotatably mounted thereon so as the enable winching operations in various directions.

The Applicant's invention described herein provides for a trailer mount for portable winch adapted to allow a user to deploy a portably winching device from an elevated position in the rear of a vehicle. The primary components in Applicant's trailer mount for portable winch are a receiver hitch extension, mounting pedestal, and mounting plate. When in operation, the trailer mount for portable winch enables more secure and effective winching from the rear of a vehicle while still allowing normal hitch operations from the same. As a result, many of the limitations imposed by prior art structures are removed.

### SUMMARY OF THE INVENTION

A trailer mount for portable winch for use with an attached conventional winching device that is attached to a conventional vehicle hitch mount behind a vehicle and allows the conventional winching to operate from an elevated position in the rear of the vehicle. The trailer mount for portable winch comprises receiver hitch extension, mounting pedestal, and mounting plate. The receiver hitch extension includes an attachment end for attaching to a conventional hitch of a vehicle as well as a receiving end on one plane, and a mounting end that extends up therefrom at a 67.5 degree angle. The mounting pedestal is adapted to be slidably positioned in the mounting end and includes a plate surface. The mounting plate is rotatably secured to the plate surface and is adapted to attach a conventional winching device to the trailer mount assembly.

It is an object of this invention to provide a trailer mount for portable winch which would provide an elevated surface from which an attachable conventional pulley style winching device can be mounted and operated.

It is another object of this invention to provide a trailer mount for portable winch which is deployed through a hitch extension so as to still allow structures to be hitched through the vehicle's hitch assembly.

It is yet another object of this invention to provide a trailer mount for portable winch having a winching device rotatably mounted thereon so as the enable winching operations in various directions.

These and other objects will be apparent to one of skill in the art.

### BRIEF DESCRIPTION OF THE DRAWINGS

FIG. 1 is a side elevational view of a trailer mount for portable winch built in accordance with the present invention.

FIG. 2A is a side elevational view of a mounting plate of a trailer mount for portable winch built in accordance with the present invention.

FIG. 2B is a bottom plan view of a mounting plate of a trailer mount for portable winch built in accordance with the present invention.

FIG. 2C is a front elevational view of a mounting plate of a trailer mount for portable winch built in accordance with the present invention

FIG. 3 is a side elevational view of a mounting pedestal of a trailer mount for portable winch built in accordance with the present invention.

FIG. 4 is a side elevational view of a receiver hitch extension of a trailer mount for portable winch built in accordance with the present invention.

### DETAILED DESCRIPTION OF THE INVENTION

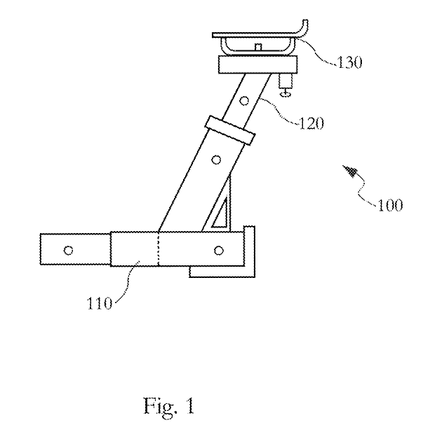

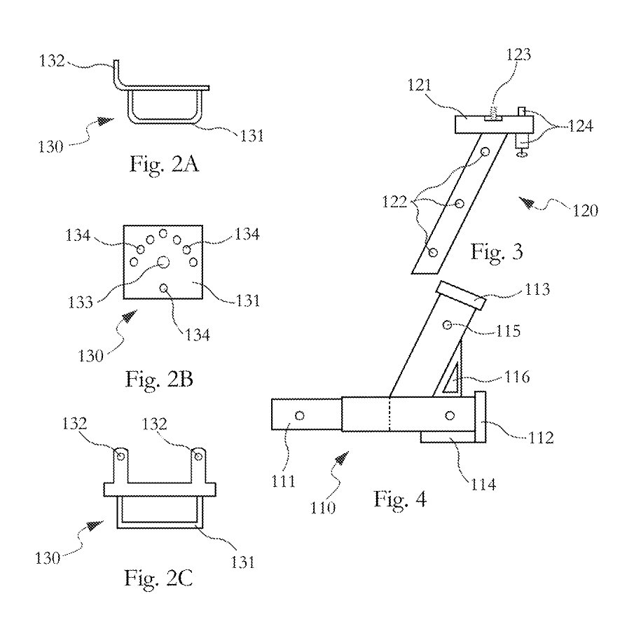

Referring now to the drawings and in particular FIGS. 1, 2A, 2B, 2C, 3, and 4, a trailer mount for portable winch 100 is shown having a receiver hitch extension 110, mounting pedestal 120, and mounting plate 130. In the preferred embodiment, the trailer mount for portable winch 100 is constructed of carbon steel tubing.

The receiver hitch extension 110 defines a hitch extension having an attachment end 111 for attaching and securing to a conventional hitch of a vehicle (not shown), a receiving end 112 for receiving and securing a conventional hitch attachment from another structure to be towed (not shown), and a mounting end 113 for receiving and securing the mounting pedestal 120. In the preferred embodiment, the mounting end 113 extends up from the plane formed by the attachment end 111 and receiving end at a 67.5 degree angle. The receiver hitch extension 110 additionally includes a safety chain plate 114 for receiving a conventional safety chain as it is secured to a conventional hitch of a vehicle, a mounting pin hole 115, and a holding aperture 116 to which a hook or clasp attached to a pulley attached to the trailer mount for portable winch 100 may be attached for storage (so as to not swing freely when not in use). It is contemplated that the receiver hitch extension 110 may be sized to operate with any conventional hitch class and size.

The mounting pedestal 120 includes a first end that is sized and shaped to be slidably positioned and secured in the mounting end 113 of the receiver hitch extension 110 and a second end having a plate surface 121 to which the mounting plate is attached. In the preferred embodiment, the mounting pedestal 120 includes three pedestal pin holes 122 at various positions, enabling the mounting pedestal 120 to be secured in the mounting end 113 at three discrete heights. It is contemplated that as with conventional hitch assemblies, the mounting pedestal 120 is secured in place in the mounting end 113 by sliding the first end of mounting pedestal 120 into the mounting end 113 until the pedestal pin hole 122 representing the desired height is aligned with the mounting pin hole 115, and then sliding a conventional securing pin (not shown) all the way through mounting end 113 and mounting pedestal 120 (by way of the aligned mounting pin holes 115 and selected pedestal pin holes 122).

The plate surface 121 defines a substantially planar surface having an attachment bolt 123 mounted thereon and a pin lock 124 integral therewith. In the preferred embodiment, the attachment bolt 123 defines an orthogonal threaded ⅞″ bolt and the pin lock 124 defines a spring loaded pin that is biased to extend up from the plate surface 121 but can be pulled down to not extend below the plate surface 121 through the application of manual force in an opening direction 125.

The mounting plate 130 includes a surface attachment level 131 and two pulley attachment tabs 132. The surface attachment level 131 defines a planar plate having a central bolt aperture 133 and a plurality of spinning apertures 134. The central bolt aperture 133 enables the mounting plate to be rotatably secured to the attachment bolt 123. The spinning apertures 134 provide receiving structures for the pin lock 124 such that when the pin lock 124 has been lowered below the plate surface 121 (through force in the opening direction 125), the mounting plate 130 can be rotated relative to the plate surface 121 to which it is attached. When force is removed, the pin lock 124 will pass through one of the spinning apertures 134, fixing the mounting plate 130 in position and preventing further rotation (until the pin lock 124 is operated again). Thus, it is contemplated that the spinning apertures 134 and pin lock 124 enable the mounting plate 130 be rotatable in a full 360 degrees and selectably fixable in one of many desired rotational positions (i.e. wherever a specific spinning aperture 134 aligns with the pin lock 124).

The pulley attachment tabs 132 are structured to enable a conventional winching device, such as a manual or motorized pulley, to be fixed to the mounting plate 130 through the use of conventional fasteners. It is contemplated that the pulley attachment tabs 132 are oriented on the mounting plate 130 so as to align with fastener receiving structures on the conventional winching device.

Through its attachment to the mounting plate 130, the conventional winching device may therefore be operated in its normal manner from a fixed, elevated position while still allowing the attachment of a trailer or other hitch mounted structure behind a vehicle to which it is mounted. Accordingly, it is contemplated that the trailer mount for portable winch 100 may be employed with a conventional winching device to pull a vehicle onto a trailer behind the vehicle to which it is mounted.

The instant invention has been shown and described herein in what is considered to be the most practical and preferred embodiment. It is recognized, however, that departures may be made therefrom within the scope of the invention and that obvious modifications will occur to a person skilled in the art.

1. A trailer mount for portable winch for attachment to a conventional vehicle hitch assembly, comprising:
a receiver hitch extension defining a hitch extension having an attachment end for attaching and securing to a conventional hitch of a vehicle and a mounting end, wherein said receiver hitch extension includes receiving end for receiving and securing a conventional hitch attachment from another structure to be towed and said receiving end is disposed on the same plane as the attachment end; and
a mounting pedestal having a first end that is sized and shaped to be slidably positioned and secured in the mounting end and a second end configured to receive a conventional winching device, wherein the mounting end extends to an elevated plane from the plane formed by the attachment end and receiving end, thereby enabling a conventional winching device on the mounting pedestal to be elevated relative to the receiving end and attachment end and wherein the mounting end extends to an elevated plane from the plane formed by the attachment end and receiving end, thereby enabling a conventional winching device on the mounting pedestal to be elevated relative to the receiving end and attachment end.

2. (canceled)

3. (canceled)

4. (canceled)

5. (canceled)

6. (canceled)

7. (canceled)

8. (canceled)

9. (canceled)

10. (canceled)

11. (canceled)

12. (canceled)
